(19) United States
(12) Patent Application Publication
(10) Pub. No.: US 2009/0100179 A1
(43) Pub. Date: Apr. 16, 2009

(54) METHOD OF CONTROLLING RESOURCES USING OUT-OF-BAND SIGNALING

(75) Inventors: Jongtae Song, Daejeon-city (KR); Soon Seok Lee, Daejeon-city (KR); Young Sun Kim, Daejeon-city (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTITUTE, Daejeon-city (KR)

(21) Appl. No.: 12/208,058

(22) Filed: Sep. 10, 2008

(30) Foreign Application Priority Data
Oct. 12, 2007 (KR) 10-2007-0103151

(51) Int. Cl. G06F 15/16

(52) U.S. Cl. 709/226

(57) ABSTRACT

Provided is a method of controlling resources using out-of-band signaling. A central admission entity checks subscription information of a user requesting resources and policies of a network for call setting, determines whether the resources are to be assigned, and distributes an IP-level flow descriptor to an edge node of the network in order to assign the resources. The edge node receiving the IP-level flow descriptor performs mapping of the IP-level flow descriptor to flow state aware (FSA) parameters, and generates a start node. Thus, a process of in-band signaling can be simplified by omitting respond and reconfirm operations.

### CROSS-REFERENCE TO RELATED PATENT APPLICATION

This application claims the benefit of Korean Patent Application No. 10-2007-0103151 filed on Oct. 12, 2007 in the Korean Intellectual Property Office, the disclosures of which are incorporated herein by reference.

### BACKGROUND OF THE INVENTION

1. Field of the Invention

The present invention relates to a method of controlling resources, and more particularly, to a method of controlling resources using out-of-band signaling in order to simplify in-band signaling.

The present invention is derived from a research project supported by the Information Technology (IT) Research & Development (R&D) program of the Ministry of Information and Communication (MIC) and the Ministry of Knowledge Economy [2006-S-064-02 BcN Network Engineering].

2. Description of the Related Art

Quality of service can be ensured by controlling ingress traffic and resources in an edge node at a network edge by using functions of controlling a network, defined by standardization organizations such as the ITU-T, etc. However, in this case, resources cannot be controlled in nodes except for the edge node.

The states of resources are requested/checked by in-band signaling, which is generally used between a start node and an end node in order to control resources. In this case, start, intermediary and end nodes need to be each controlled so as to recognize the resources and to process and store contents of requested services. Each of the start, intermediary and end nodes needs to manage the states of the resources. When conversion of the states is complicated, since conversion and tracking of the states by each of the start, intermediary and end nodes depend on software, a processing load for controlling resources of a node is increased. Thus, when services are requested, a time delay in terms of processing resources, etc. may occur due to the overload.

### SUMMARY OF THE INVENTION

The present invention provides a method of controlling resources using out-of-band signaling in order to simplify in-band signaling performed between transmission apparatuses of a network.

According to an aspect of the present invention, there is provided a method of controlling resources in a central admission entity, the method including checking resources and policies of a network for performing a call setting; checking subscription information of a user requesting the call setting; and distributing an IP-level flow descriptor to an edge node of the network when assigning resources for the call setting.

According to another aspect of the present invention, there is provided a method of controlling resources in a network edge node, the method including receiving an IP-level flow descriptor from a central admission entity managing network resources; and performing mapping of the IP-level flow descriptor to flow state aware (FSA) parameters.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a system using out-of-band signaling, according to an embodiment of the present invention;

FIG. 2 is a flowchart of a method of controlling resources using out-of-band signaling, according to an embodiment of the present invention; and

FIG. 3 is a block diagram of a transmission apparatus for performing a function of controlling a network, according to an embodiment of the present invention

### DETAILED DESCRIPTION OF THE INVENTION

A terminal needs to be independent of the network so that resources of the network are ensured regardless of a method of controlling resources of a network. To achieve this, a method using a network control function is suggested. A resource control structure using the network control function ensures service qualities by using the same network with respect to various application services. Currently, various standardization organizations have defined detailed control procedures and structures of the resource control structure. Since a service layer including various application services and a transmission layer for transmitting data are independent, a resource control request is transmitted to an entity having the network control function through the service layer when the network resources is needed to achieve quality of service.

In particular, when the entity having the network control function receives a resource reservation request through an application service layer, the entity can assign the resources of a corresponding service to an edge node of a network. Likewise, when a network is controlled using the edge node, the network can be approximately stabilized by controlling the total amount of traffic entering network and bandwidth. However, since an intermediary node cannot control traffic, traffic entering the network might be caused, unstability such as traffic congestion, when passing through the intermediary node. Thus, the quality of service cannot be ensured.

Path coupled signaling is largely used in order to reserve resources of intermediary nodes. In the path coupled signaling, a resource request message is transmitted to the intermediary node via a path through which data flows, and data are transmitted from a start point, after confirming the resource reservation of the intermediary node. An example of the path coupled signaling may be reservation protocol (RSVP), etc. In this case, a node of a start point transmits a resource control request, confirms a resource reservation, and then transmits data. However, in the process of requesting, confirming and reconfirming resources reservation, a control function of managing the state of resources is required. In a network through which large amounts of services pass, the resource state management can put a load on the network equipment. Thus, it is sufficient to embody a resource control function as hardware in order to reduce the load on a node and quickly process large amounts of requests.

The present invention uses a network control function in order to control resources of an intermediary node disposed on a network path. In order to perform the network control function, an application service and a transmission network are connected in order to ensure resources and service qualities. All services use a network control function in order to request resources when the quality of service needs to be ensured. During the performing of the network control function, a topology of a network and the state of resources are checked, and it is determined whether the resource request is confirmed, according to the check result. Since the state of network resources is checked using the network control function, in-band signaling required to check the state of resources can be simplified using the state of network resources.

Hereinafter, a method of controlling resources will be described with regard to exemplary embodiments of the invention with reference to the attached drawings.

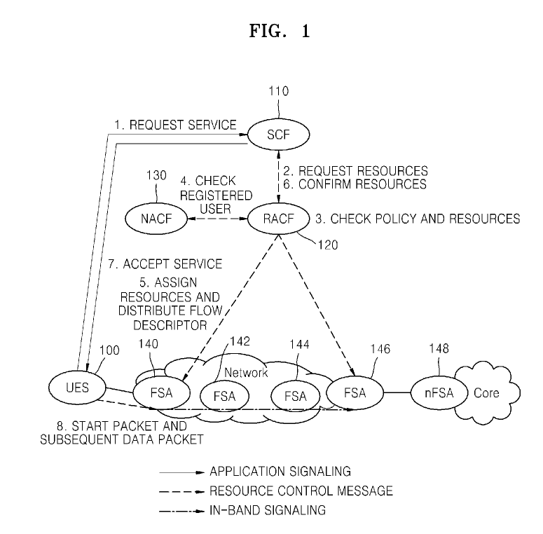

FIG. 1 illustrates a system using out-of-band signaling, according to an embodiment of the present invention.

Referring to FIG. 1, the system includes a resource control entity (referred to as a resource and admission control function (RACF)) 120, a network attachment control entity (hereinafter, referred to as a network attachment control function (NACF)) 130, a service control entity (hereinafter, referred to as a service control function (SCF)) 110, a user end system (UES) 100 at an end of a network, and transmission entities (hereinafter, referred to as flow state aware (FSAs) 140,142,144,146 and 148, transmitting data to a network.

The UES 100 requests the SCF 110 for a service for call in order to communicate with another UES or a server.

The SCF 110 exchanges information through an application service level with the UES 100 in order to provide the service requested by the UES 100, and requests the RACF 120 for network resources and receives assignment of the network resources needed for a quality of service when the network resources are required in order to provide the service.

The RACF 120 determines whether the request for the service is to be accepted, according to the state of resources of a network. When the RACF 120 determines that the request for the service is to be accepted, the RACF 120 provides and assigns the resources required for the service to the FSAs 140,142,144,146 and 148.

The FSAs 140,142,144,146 and 148 may include an ingress node 140 and an egress node 146, disposed at the network edge, and transit nodes 142 and 144, disposed on the network path. The ingress node 140 and the egress node 146 manage the resources under the control of the RACF 120, which the transit nodes 142 and 144 cannot do. Thus, in-band QoS signaling is required to control the resources of the transit nodes 142 and 144.

Signaling for controlling resources is largely classified into signaling of the application level, performed between the UES 100 and the SCF 110, signaling of controlling resources, performed between the SCF 110, the RACF 120 and the FSAs 140 and 146 in order to assign the resources, and in-band signaling, performed between the FSAs 140,142,144,146 and 148.

In the present embodiment, since a central admission entity such as the RACF 120 precisely performs an admission function, the FSAs 140,142,144,146 and 148 do not require a message overhead for response and confirmation.

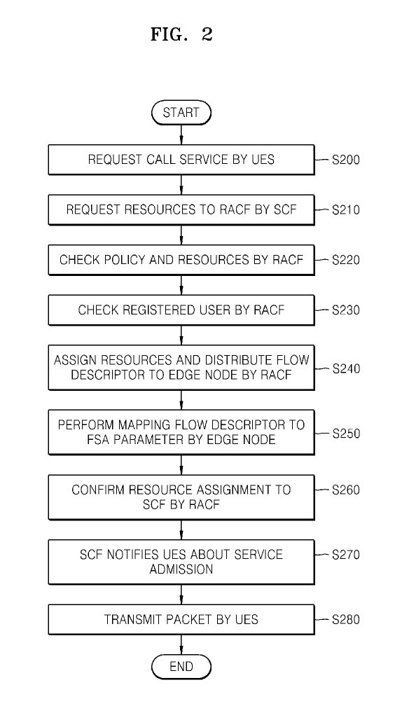

When a method of controlling resources, according to the present embodiment, is combined with proxy signaling, the UES 100, registered in order to manage the FSAs 140,142,144,146 and 148, can simply initiate a call without a FSA signaling capability. Through the process for a call-level authority and admission, IP-level traffic parameters (i.e., RACF traffic descriptors) can be informed to the RACF 120. Then, the RACF 120 distributes the traffic descriptor to appropriate ingress nodes, which are working signaling proxies. The ingress nodes perform mapping of the IP-level traffic descriptor distributed by the RACF 120 to FSA parameters prior to transmitting a start packet. Thus, UESs do not need to register their own FSA parameters to a proxy. The above method of controlling resources will be described with reference to FIG. 2.

FIG. 2 is a flowchart of a method of controlling resources using out-of-band signaling, according to an embodiment of the present invention.

Referring to FIGS. 1 and 2, the UES 100 requests the SCF 110 for the service for the call, according to an application program (operation S200). The SCF 110 may be an application server using a session initiation protocol (SIP) for setting the call. When network resources are required in the process of setting the call, the SCF 110 requests the RACF 120, which is a central admission entity performing a network controlling function, for the required resources (operation S210).

The RACF 120 determines whether the requested resources are to be accepted, in consideration of the states of network resources and network policies. In particular, the RACF 120 checks a policy that can be applied to a flow, etc. in addition to the call requested by the UES 100, and checks resources that can be used in a network (operation S220). When it is determined that the requested resources are to be accepted using the check operation, the RACF 120 checks subscription information of a user via the NACF 130 (operation S230). That is, the RACF 120 determines whether the resources are to be accepted, based on the maximum bandwidth that is registered in the subscription information. When the resources are to be accepted, information regarding resources to be assigned to the edge node disposed at the network edge, that is, an IP level flow descriptor, is distributed (operation S240). When an ingress edge nodes operates as a signaling proxy, the edge node performs mapping of the IP level flow descriptor to FSA quality of service (QoS) parameters such as a service context, a burst tolerance, a delay priority, etc. (operation S250). The FSA QoS parameters are stored in the edge node. The RACF 120 notifies the SCF 110 about the confirmation of resources that can be used (operation S260). The SCF 110 notifies the UES 100 that the call service is to be accepted. Then, the UES 100 transmits packets (operation S280).

Resources are assigned through the above operations. Hereinafter, a method of transmitting a packet via a network to which resources are assigned will be described.

The UES 100 generates an in-band FSA request signal. All FSAs disposed on a path recognize the in-band FSA request signal and store FSA parameters for a flow. When the ingress node 140 operates a proxy, the UES 100 transmits only a general data packet. In this case, when the ingress node 140 recognizes a first data packet transmitted from the UES 100, the ingress node 140 generates a start packet by using an FSA parameter mapped from the IP level flow descriptor received from the RACF 120.

The RACF 120 may check a requested data rate of the flow, that is, a rate requested by FSA. Parameters, such as a preference indicator, a service context, a burst tolerance, or a delay priority, may be inferred from the IP level descriptor received from the RACF.

When a packet arrives at the ingress node 140, the ingress node 140 ensures resources of a transmission node, which is an intermediary node, via in-band signaling. At this time, the ingress node 140 may transmit a separate message indicating a resource value (e.g., the maximum bandwidth, an average bandwidth, a burst size, etc.) via the in-band signaling, or alternatively, may encode the resource value to a header of an IP packet and transmit the resource value.

Generally, in in-band signaling, a result of obtaining resources on a path is reported, and then a packet is transmitted. However, since the RACF 120 of a control plane watches the state of network resources and the ingress node 140 receives admission from the control plane, it is not required that the ingress node 140 respond to in-band signaling. Thus, in the present embodiment, it is not required that the ingress node 140 performs complicated processes such as responding to in-band signaling and reconfirmation with respect to in-band signaling.

In short, a negotiation operation of each node of a network is performed using complete in-band signaling (when including respond and confirm operations) or using the in-band signaling combined with authorization signaling with respect to the RACF 120, that is, out-of-band signaling. In the latter case, a start packet may be generated in an ingress node by mapping an IP-level flow descriptor (e.g., an RACF traffic descriptor) to FSA parameters.

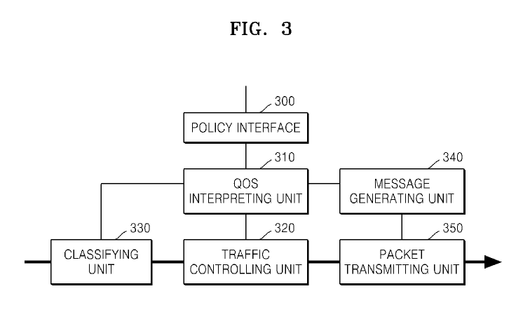

FIG. 3 is a block diagram of a transmission apparatus for performing a function of controlling a network, according to an embodiment of the present invention.

Referring to FIG. 3, the transmission apparatus, which is an FSA such as an ingress node, an egress node, a transmission node, etc., may include a policy interface 300, a QoS interpreting unit 310, a traffic controlling unit 320, a classifying unit 330, a message generating unit 340 and a packet transmitting unit 350.

The policy interface 300 transmits and receives QoS information regarding a network control function, that is, an RACF and QoS policy. The QoS interpreting unit 310 converts the QoS information, which is received regardless of transmission technology, in a form appropriate to pertaining transmission technology.

The traffic controlling unit 320 performs scheduling and queue-controlling, so that data traffic is controlled and requested resources are used. The message generating unit 340 generates a control message for in-band signaling.

The classifying unit 330 analyses the received packet in units of a flow to be controlled, and divides the control message. The packet transmitting unit 350 transmits a data packet and a control packet to a next node.

In particular, an operation of an ingress node of a network will be described.

The policy interface 300 receives resource request information from an entity having a control function. The QoS interpreting unit 310 converts the received resource request information to QoS information appropriate to transmission technology. The traffic controlling unit 320 modifies the QoS information that is converted from the resource request information so as to traffic-control the QoS information. The classifying unit 330 adds the classifying rule to the QoS information that is modified in the traffic controlling unit 320 so as to classify the QoS information in each flow. In addition, the message generating unit 340 generates an in-band control signal, and transmits the in-band control signal.

An operation of each of an egress node and an intermediary node is similar to the operation of the ingress node. The ingress node receives the resource control request through the control plane. However, in the case of the egress node or the intermediary node, resource control information is received via the classifying unit 330, which is a data receiving module, and then transmitted via the QoS interpreting unit 310 to the traffic controlling unit 320 so as to achieve traffic control. Thus, the message generating unit 340 is not required.

According to the present invention, respond and reconfirm operations are omitted in in-band signaling used in order to assign resources of an intermediary node on a path of a network, and thus the in-band signaling is simplified. Thus, a signal processing load can be reduced in each transmission apparatus of a network. In addition, it is easy to embody simplified in-band signaling as hardware.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling resources in a central admission entity, the method comprising:
checking resources and policies of a network for performing a call setting;
checking subscription information of a user requesting the call setting; and
distributing an IP-level flow descriptor to an edge node of the network when assigning resources for the call setting.

2. The method of claim 1, wherein the checking of the resources and the policy comprises checking the resources and the policy when receiving a network resource request for the call setting from a service control entity connected to a user terminal.

3. The method of claim 1, wherein the checking of the subscription information of the user comprises determining whether resources for the call setting are to be assigned by checking a maximum bandwidth for which a user is registered.

4. The method of claim 1, wherein the checking of the subscription information of the user comprises checking the subscription information of the user, which is stored in a network attachment control entity.

5. The method of claim 1, wherein the distributing comprises distributing the IP-level flow descriptor to an ingress node in which the edge node operates as a signaling proxy.

6. A method of controlling resources in a network edge node, the method comprising:
receiving an IP-level flow descriptor from a central admission entity managing network resources; and
performing mapping of the IP-level flow descriptor to flow state aware (FSA) parameters.

7. The method of claim 6, further comprising generating a start packet by using the FSA parameters when a first packet is received from a user terminal.

8. A computer readable recording medium having recorded thereon a program for executing the method of claim 1.

9. A computer readable recording medium having recorded thereon a program for executing the method of claim 6.
